(19) United States
(12) Patent Application Publication
(10) Pub. No.: US 2014/0237195 A1
(43) Pub. Date: Aug. 21, 2014

(54) N-DIMENSIONAL COLLAPSIBLE FIFO

(71) Applicant: APPLE INC., Cupertino, CA (US)

(72) Inventors: Peter F. Holland, Los Gatos, CA (US); Hao Chen, San Ramon, CA (US); Albert C. Kuo, Mountain View, CA (US)

(73) Assignee: APPLE INC., Cupertino, CA (US)

(21) Appl. No.: 13/771,861

(22) Filed: Feb. 20, 2013

(51) Int. Cl. G06F 5/06

(52) U.S. Cl. CPC G06F 5/065
USPC 711/147

(57) ABSTRACT

A system and method for efficient dynamic utilization of shared resources. A computing system includes a shared data structure accessed by multiple requestors. Both indications of access requests and indices pointing to entries within the data structure are stored in storage buffers. Each storage buffer maintains at a selected end an oldest stored indication of an access request from a respective requestor. Each storage buffer stores information for the respective requestor in an in-order contiguous manner beginning at the selected end. The indices stored in a given storage buffer are updated responsive to allocating new data or deallocating stored data in the shared data structure. Entries in a storage buffer are deallocated in any order and remaining entries are collapsed toward the selected end to eliminate gaps left by the deallocated entry.

### BACKGROUND OF THE INVENTION

1. Field of the Invention

This invention relates to semiconductor chips, and more particularly, to efficient dynamic utilization of shared storage resources.

2. Description of the Relevant Art

A semiconductor chip may include multiple functional blocks or units, each capable of generating access requests for data stored in a shared storage resource. In some embodiments, the multiple functional units are individual dies on an integrated circuit (IC), such as a system-on-a-chip (SOC). In other examples, the multiple functional units are individual dies within a package, such as a multi-chip module (MCM). In yet other examples, the multiple functional units are individual dies or chips on a printed circuit board. The shared storage resource may be a shared memory comprising flip-flops, latches, arrays, and so forth.

The multiple functional units on the chip are requestors that generate memory access requests for a shared memory. Additionally, one or more functional units may include multiple requestors. For example, a display subsystem in a computing system may include multiple requestors for graphics frame data. The design of a smartphone or computer tablet may include user interface layers, cameras, and video sources such as media players. A given display pipeline may include multiple internal pixel-processing pipelines. The generated access requests or indications of the access requests may be stored in one or more resources.

When multiple requestors are active, assigning the requestors to separate copies or versions of a resource may reduce the design and the communication latencies. For example, a storage buffer or queue includes multiple entries, wherein each entry is used to store an access request or an indication of an access request. Each active requestor may have a separate associated storage buffer. Additionally, multiple active requestors may utilize a single storage buffer. The single storage buffer may be partitioned with each active requestor assigned to a separate partition within the storage buffer. Regardless of the use of a single, partitioned storage buffer or multiple assigned storage buffers, when a given active requestor consumes its assigned entries, this static partitioning causes the given active requestor to wait until a portion of its assigned entries are deallocated and available once again. The benefit of the available parallelization is reduced.

Additionally, while the given active requestor is waiting, entries assigned to other active requestors may be unused. Accordingly, the static partitioning underutilizes the storage buffer(s). Further, the size of the data to access may be significantly large. Storing the large data within an entry of the storage buffer for each of the active requestors may consume an appreciable amount of on-die real estate. Alternatively, a separate shared storage resource may include entries corresponding to entries in the storage buffer(s). Again, though, the number of available requestors times the significantly large data size times the number of corresponding storage buffer entries may exceed an on-die real estate threshold.

In view of the above, methods and mechanisms for efficiently processing requests to a shared resource are desired.

### SUMMARY OF EMBODIMENTS

Systems and methods for efficient dynamic utilization of shared resources are contemplated. In various embodiments, a computing system includes a shared data structure accessed by multiple requestors. In some embodiments, the shared data structure is an array of flip-flops or a random access memory (RAM). The requestors may be functional units that generate memory access requests for data stored in the shared data structure. Either the generated access requests or indications of the access requests may be stored in one or more separate storage buffers. Stored indications of access requests may include at least an identifier (ID) used to identify response data corresponding to the access requests.

The storage buffers may additionally store indices pointing to entries in the shared data structure. Each of the one or more storage buffers may maintain an oldest stored indication of an access request from a given requestor at a first end. Therefore, no pointer may be used to identify the oldest outstanding access request for an associated requestor. Control logic may identify a given one of the storage buffers corresponding to a received access request from a given requestor. An entry of the identified storage buffer may be allocated for the received access request. The control logic may store indications of access requests for the given requestor and corresponding indices pointing into the shared data structure in an in-order contiguous manner in the identified storage buffer beginning at a first end of the identified storage buffer.

The control logic may update the indices stored in a given storage buffer responsive to allocating new data in the shared data structure. Additionally, the control logic may update the indices responsive to deallocating stored data in the shared data structure. The control logic may deallocate entries within a storage buffer in any order. In response to detecting an entry corresponding to the given requestor is deallocated, the control logic may collapse remaining entries to eliminate any gaps left by the deallocated entry. In various embodiments, such collapsing may include shifting remaining allocated entries of the given requestor toward an end of the storage buffer so that the gaps mentioned above are closed.

These and other embodiments will be further appreciated upon reference to the following description and drawings.

### BRIEF DESCRIPTION OF THE DRAWINGS

FIG. 1 is a generalized block diagram of one embodiment of shared data storage.

FIG. 2 is a generalized block diagram of another embodiment of shared data storage.

FIG. 3 is a generalized flow diagram of one embodiment of a method for efficient dynamic utilization of shared resources.

FIG. 4 is a generalized flow diagram of one embodiment of a method for dynamically accessing shared split resources.

FIG. 5 is a generalized block diagram of another embodiment of a display controller.

FIG. 6 is a generalized block diagram of one embodiment of internal pixel-processing pipelines.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six, interpretation for that unit/circuit/component.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention.

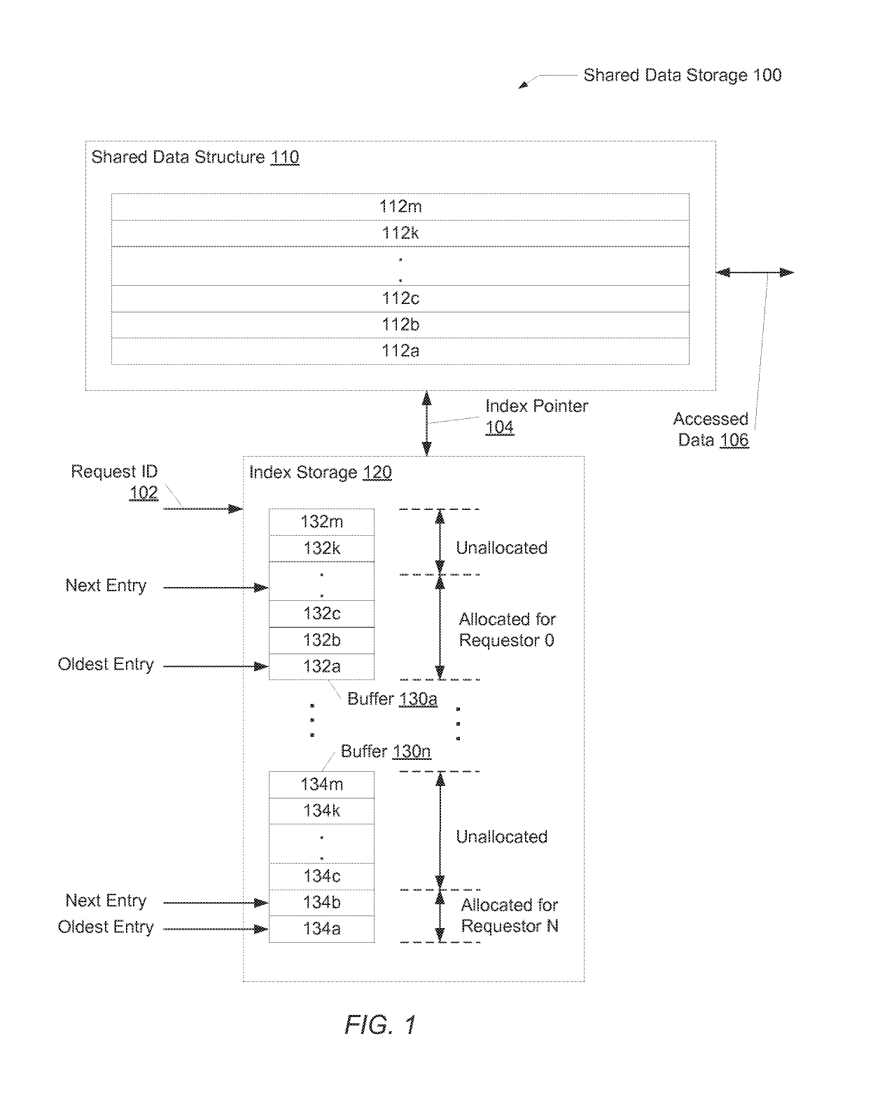

Referring to FIG. 1, one embodiment of shared data storage 100 is shown. In various embodiments, the shared data structure 110 is an array of flip-flops or a random access memory (RAM) used for data storage. Multiple requestors (not shown) may generate memory access requests for data stored in the shared data structure 110. The shared data structure 110 may comprise a plurality of entries including entries 112a-112m. A tag, an address or a pointer may be used to identify a given entry of the entries 112a-112m. The identifying value may be referred to as an index pointer, or simply an index. The index storage 120 may store the index used to identify the given entry in the shared data structure 110.

In some embodiments, the entries 112a-112m within the shared data structure 110 are allocated and deallocated in a dynamic manner, wherein a content addressable memory (CAM) search is performed to locate a given entry storing particular information. An associated index, such as a tag, may also be stored within the entries 112a-112m and used for a portion of the search criteria. Status information, such as a valid bit and a requestor ID, may also be used in the search. Control logic used for allocation, deallocation, the updating of counters and pointers, and other functions for each of the shared data structure 110 and the index storage 120 is not shown for ease of illustration.

The index storage 120 may include a plurality of storage buffers 130a-130n. In some embodiments, a number of storage buffers 130a-130n are the same as a maximum number of active requestors. For example, there may be a maximum number of N active requestors, wherein N is an integer. There may also be N buffers within the index storage 120. Therefore, in some embodiments, each of the possible N active requestors may have a corresponding buffer in the index storage 120. In addition, a corresponding one of the buffers 130a-130n may maintain an oldest stored indication of an access request from a given requestor at a selected end of the buffer. For example, the bottom end of a buffer may be selected for maintaining the oldest stored indication of an access request from the given requestor. Alternatively, the top end may be the selected end. Therefore, no pointer register is needed to determine the entry storing information corresponding to the oldest outstanding access request for the given requestor. Each of the storage buffers 130a-130n may include multiple entries. For example, buffer 130a includes entries 132a-132m. Buffer 130n may include entries 134a-134m.

In some embodiments, a maximum number of outstanding requests for the shared data storage is limited. For example, the number of outstanding requests may be limited to M, wherein M is an integer. In various embodiments, one or more of the buffers 130a-130n include M entries. Therefore, in various embodiments, there may be N buffers, each with M entries within the index storage 120. Accordingly, the shared data structure 110 may have a maximum of M valid entries storing data for outstanding requests. In such embodiments, each requestor may have an associated buffer of the buffers 130a-130n. It is noted when there is only one active requestor, the single active requestor may have a number of outstanding requests equal to the limit of M outstanding requests.

A given requestor of the multiple requestors may generate a memory access request, or simply, an access request. The access request may be sent to the shared data storage 100. The received access request may include at least an identifier (ID) 102 used to identify response data corresponding to the received access request. Control logic may identify a given one of the buffers 130a-130n for the given requestor and store at least the ID in an available entry of the identified buffer. An indication may be sent from the index storage 120 to the data structure 110 referencing the received access request. An available entry in the data structure 110 may be allocated for the received access request. An associated index 104 for the available entry may be sent from the data structure 110 to the index storage 120.

The received index 104 may be stored with the received ID 102 in the previously identified buffer. The stored index may be used during later processing of the access request to locate the data associated with the access request. Access data 106 may be read or written based on the access request. The stored index may also be later used to locate and deallocate the corresponding entry in the data structure 110 when the access request is completed. In various embodiments, the size of the data stored in the data structure 110 may be significantly large. This data size used in the data structure 110 times the maximum number M of outstanding access requests times 2 requestors may exceed a given on-die real estate threshold. Both efficiently maintaining the location of the oldest outstanding request for one or more of the multiple requestors and storing a significantly large data size may cause the data storage to be split as shown between the data structure 110 and the index storage 120.

If the data in the data structure 110 was alternately stored in the buffers 130a-130n of the index storage 120, an appreciable amount of on-die real estate may be consumed by the index storage 120. Two requestors are chosen for the multiplication, since a number of 2 active requestors is the minimum number of requestors for having multiple requestors and already doubles the amount of on-die real estate to use for storing the significantly large data. The sizes of the indices and the request IDs stored in the index storage 120 are relatively small compared to the data stored in the data structure 110.

In some embodiments, the entries in the buffers 130a-130n are allocated and deallocated in a dynamic manner. Similar to the entries 112a-112m in the data structure 110, a content addressable memory (CAM) search may be performed to locate a given entry storing particular information in a given one of the buffers 130a-130n. Age information may be stored in the buffer entries. In other embodiments, the entries are allocated and deallocated in a first-in-first-out (FIFO) manner. Other methods and mechanisms for allocating and deallocating one or more entries at a time are possible and contemplated.

In various embodiments, when a given requestor is active, buffer entries within a corresponding one of the buffers 130a-130n may be allocated for use for the given requestor beginning at the bottom end of the corresponding buffer. Alternatively, in other embodiments, the top end may be selected as the beginning. For the given requestor, the buffer entries may be allocated for use in an in-order contiguous manner beginning at the selected end, such as the bottom end, of the corresponding buffer.

One or more buffer entries may be allocated at a given time, but the entries corresponding to newer information are placed farther away from the bottom end. For example, if the entries store indications of access requests, then the entries corresponding to the given requestor are allocated in-order by age from oldest to youngest indication moving from the bottom end of the buffer upward. Therefore, entry 134c is younger than the entry 134b in buffer 130n. Entry 134b is younger than the entry 134a, and so forth. The control logic for the index storage 120 maintains the oldest stored indication of an access request for the given requestor at the bottom end of the corresponding buffer. An example is entry 134a in buffer 130n. Again, in other embodiments, the selected end for storing the oldest indication of an access request may be the top end of the corresponding buffer.

The processing of the access requests corresponding to the indications stored in a corresponding buffer may occur in-order. Alternatively, the processing of these access requests may occur out-of-order. In various embodiments, entries within a corresponding buffer of the buffers 130a-130n may be deallocated in any order. In response to determining an entry corresponding to the given requestor has been deallocated, a gap may be opened amongst allocated entries. For example, if entry 132b is deallocated in buffer 130a, a gap between entries 132a and 132c is created (an unallocated entry bounded on either side by allocated entries). In response, entry 132c and other allocated entries above entry 132c may be shifted toward entry 132a in order to close the gap. This shifting to close gaps may generally be referred to as “collapsing.” In this manner, all allocated entries will generally be maintained at one end of the corresponding buffer with unallocated entries appearing at the other end.

Maintaining the oldest stored indications at a selected end, such as the bottom end, of the corresponding buffer may simplify control logic. No content addressable memory (CAM) or other search is performed to find the oldest stored indication for the given requestor. Response data corresponding to valid allocated entries within the corresponding buffer may be returned out-of-order. Therefore, entries in the corresponding buffer are deallocated in any order and remaining entries are collapsed toward the selected end to eliminate gaps left by the deallocated entry. Deallocation and marking of completion in other buffers in later pipeline stages may be performed in-order by age from oldest to youngest. The oldest stored information at the bottom end of the buffer may be used as a barrier to the amount of processing performed in pipeline stages and buffers following the shared data storage 100. The response data may be further processed in later pipeline stages in-order by age from oldest to youngest access requests after corresponding entries are deallocated within the corresponding buffer.

When the buffers 130a-130n are used in the above-described manner, each of the buffers 130a-130n may operate as a collapsible FIFO buffer. When multiple requestors are active, the entries within the buffers 130a-130n and the entries within the shared data structure 110 may be dynamically allocated to the requestors based on demand and a level of activity for each of the multiple requestors.

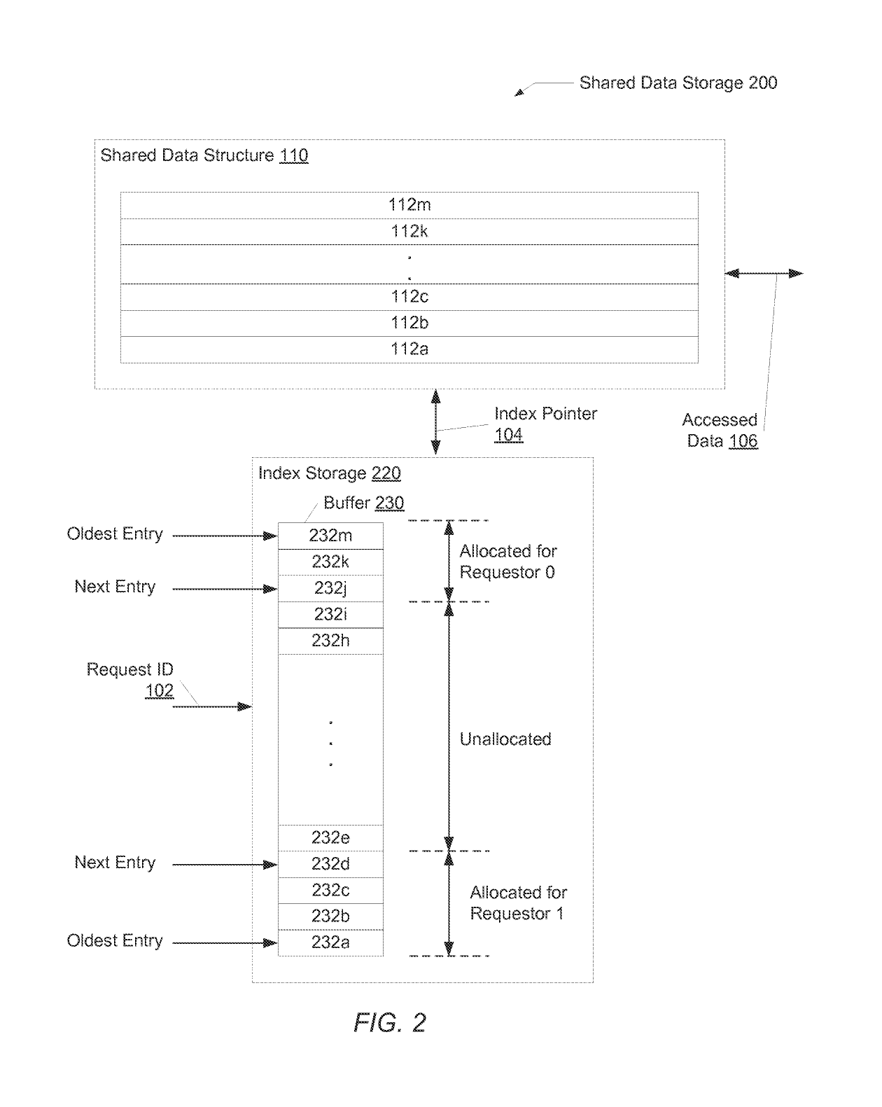

Turning now to FIG. 2, another embodiment of shared data storage 200 is shown. Circuitry and logic already described above are numbered identically here. The index storage 220 may include one or more buffers. Here, a single buffer 230 is shown for ease of illustration although multiple buffers may be used. For example, if each of the buffers in the index storage 220 uses the configuration of buffer 230, then there may be N/2 buffers, each with M entries. Here, N is used again as the maximum number of active requestors and M is used as the maximum number of outstanding requests. Similar to the shared data storage 100, the control logic for the shared data storage 200 for allocation, deallocation, the updating of counters and pointers, and other functions is not shown for ease of illustration.

The buffer 230 may include multiple entries such as entries 232a-232m. Each entry within the buffer 230 may be allocated for use by two requestors indicated by requestor 0 and requestor 1. For example, if the requestor 0 is inactive and the requestor 1 is active, the entries 232a-232m within the buffer 230 may be utilized by the requestor 1. The reverse scenario is also true. If the requestor 1 is inactive and the requestor 0 is active, each of the entries within the buffer 230 may be allocated and utilized by the requestor 0. No given quota or limit inside of the limit M may be set for the requestors 0 and 1.

In various embodiments, when each of the requestor 0 and the requestor 1 is active, the entries are allocated for use for the requestor 0 beginning at the top end of the buffer 230. Similarly, the entries are allocated for use for the requestor 1 beginning at the bottom end of the buffer 230. For the requestor 0, the entries may be allocated for use in an in-order contiguous manner beginning at the top end of the buffer 230. One or more entries may be allocated at a given time, but the entries corresponding to newer information are placed farther away from the top end. For example, if the entries store indications of access requests, then the entries corresponding to the requestor 0 are allocated in-order by age from oldest to youngest indication moving from the top end of the buffer 230 downward. Therefore, entry 232j is younger than the entry 232k, which is younger than the entry 232m. The control logic for the buffer 230 maintains the oldest stored indication of an access request for the requestor 0 at the top end of the buffer 230, or the entry 232m.

For the requestor 1, the entries may be allocated for use in an in-order contiguous manner beginning at the bottom end of the buffer 230. One or more entries may be allocated at a given time, but the entries corresponding to newer information are placed farther away from the bottom end. The entries corresponding to the requestor 1 are allocated in-order by age from oldest to youngest indication moving from the bottom end of the buffer 230 upward. Therefore, entry 232d is younger than the entry 232c, which is younger than the entry 232b, and so forth. The control logic for the buffer 230 maintains the oldest stored indication of an access request for the requestor 1 at the bottom end of the buffer 230, or the entry 232a.

The processing of the access requests corresponding to the indications stored in the buffer 230 may occur in-order. Alternatively, the processing of these access requests may occur out-of-order. The stored indications of access requests may include at least an identifier (ID) used to identify response data corresponding to the access requests and an index for identifying a corresponding entry in the shared data structure 110 for storing associated data of a significantly large size.

In various embodiments, entries within the buffer 230 may be deallocated in any order. In response to determining an entry corresponding to the requestor 0 has been deallocated, a gap may be opened amongst allocated entries. For example, if entry 232k is deallocated, a gap between entries 232m and 232j is created (an unallocated entry bounded on either side by allocated entries). In response, entry 232j may be shifted toward entry 232m in order to close the gap. This shifting to close gaps may generally be referred to as “collapsing.” In this manner, all allocated entries will generally be maintained at one end of the buffer 230 or the other—with unallocated entries appearing in the middle.

Maintaining the oldest stored indications at the top end and the bottom end of the buffer 230 may simplify other logic surrounding the buffer 230. No content addressable memory (CAM) or other search is performed to find the oldest stored indications for the requestors 0 and 1. Response data corresponding to valid allocated entries within the buffer 230 may be returned out-of-order. Therefore, entries in the buffer 230 are deallocated in any order and remaining entries are collapsed toward the selected end to eliminate gaps left by the deallocated entry. Deallocation and marking of completion in other buffers in later pipeline stages may be performed in-order by age from oldest to youngest. The oldest stored information at the selected end of the buffer may be used as a barrier to the amount of processing performed in pipeline stages and buffers following the shared data storage 200. The response data may be further processed in later pipeline stages in-order by age from oldest to youngest access requests after corresponding entries are deallocated within the buffer 230.

When the buffer 230 is used in the above-described manner as a storage buffer, the buffer 230 may operate as a bipolar collapsible FIFO buffer. When the two requestors are both active, the entries within the buffer 230 may be dynamically allocated to the requestors based on demand and a level of activity for each of the two requestors.

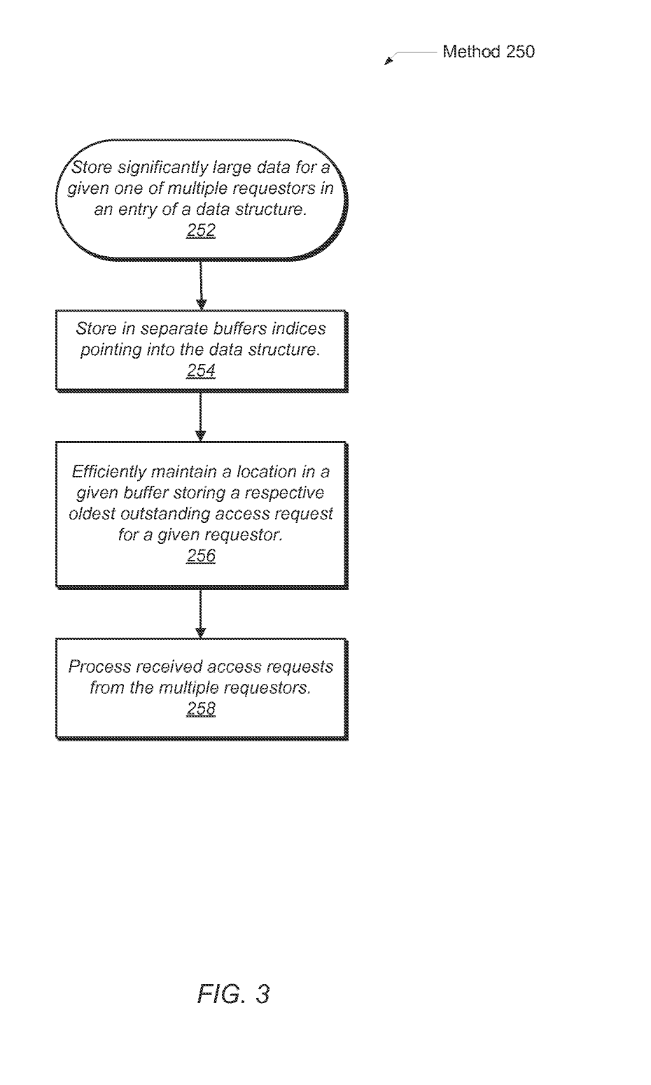

Referring now to FIG. 3, a generalized flow diagram of one embodiment of a method 250 for efficient dynamic utilization of shared resources is shown. For purposes of discussion, the steps in this embodiment are shown in sequential order. However, in other embodiments some steps may occur in a different order than shown, some steps may be performed concurrently, some steps may be combined with other steps, and some steps may be absent.

In block 252, significantly large data may be stored for a given one of multiple requestors in an entry of a shared data structure. The shared data structure may be an array of flip-flops, a RAM, or other. The significantly large data size stored in an entry in the data structure times a maximum number M of outstanding access requests times 1 requestor may reach a given on-die real estate threshold. Adding another entry of the data size for storing data may exceed the threshold.

In block 254, indices pointing to entries in the shared data structure may be stored in separate buffers. In various embodiments, a number of separate buffers may equal a number N of possible active requestors, wherein each requestor has a corresponding buffer. In block 256, one or more of the buffers may efficiently maintain a location storing a respective oldest outstanding access request for a given requestor. For example, a selected end of the buffer may store the oldest outstanding access request for the given requestor. No pointer may be used to identify the oldest outstanding access request for the given requestor. In some embodiments, the buffers may be used as collapsible FIFOs.

In other embodiments, a number of separate buffers may equal N/2, wherein two requestors share a given buffer. The buffers may be used as bipolar collapsible FIFOs. In yet other embodiments, some buffers may be used for a single requestor and may be used as a collapsible FIFO while other buffers may be used for two requestors and may be used as a bipolar collapsible FIFO. Any ratio of the two types of buffers and their use is possible and contemplated. It is noted that while a give buffer may be referred to herein as a FIFO, it is to be understood that in various embodiments a strict first-in-first-out ordering is not required. For example, in various embodiments, entries within the FIFO may be processed and/or deallocated in any order—irrespective of an order in which they were placed in the FIFO.

In block 258, received access requests from the multiple requestors, such as N requestors, are processed. The processing of the access requests for all of the active requestors and the returning of the response data corresponding to the indications stored in a corresponding buffer may occur in any order. When an access request is processed, corresponding entries in the data structure and an associated buffer may be deallocated. If a gap is created in a collapsible FIFO, the allocated entries for the requestor may be shifted in order to collapse the entries toward the selected end and remove the gap.

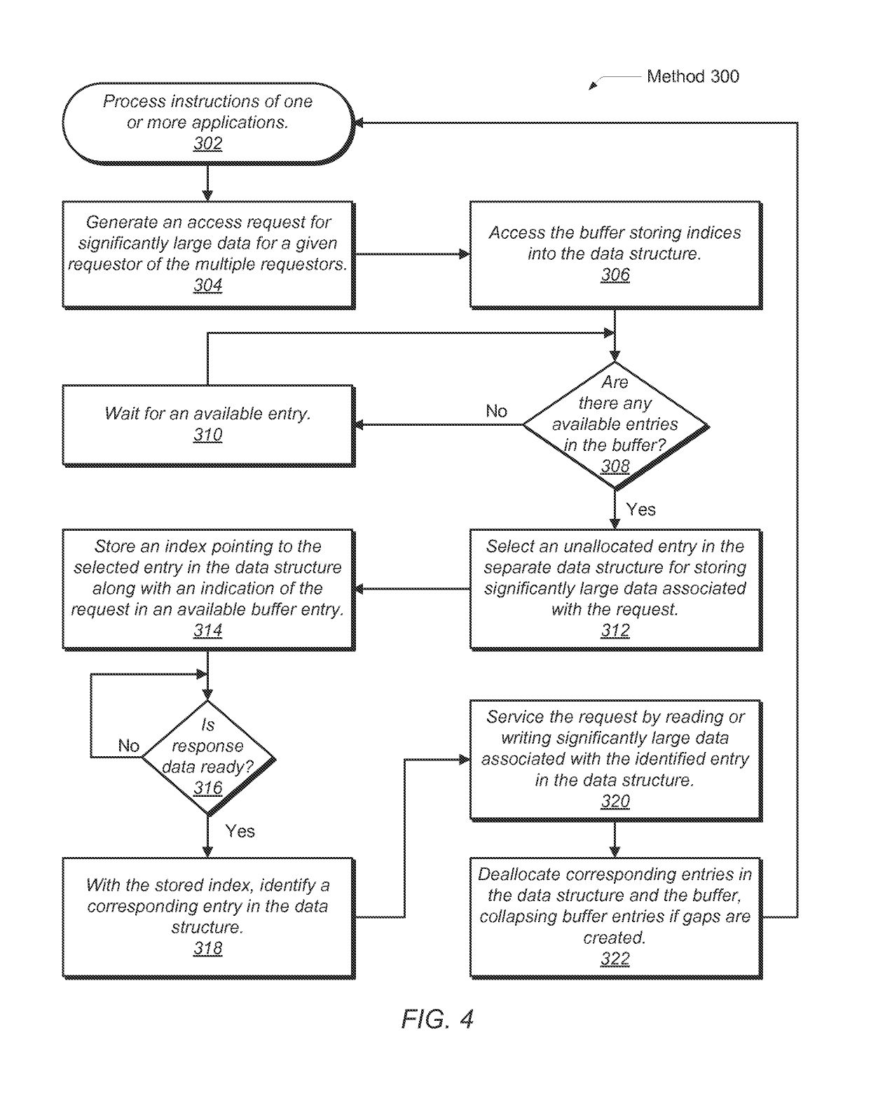

Referring now to FIG. 4, a generalized flow diagram of one embodiment of a method 300 for dynamically accessing shared split resources is shown. For purposes of discussion, the steps in this embodiment are shown in sequential order. However, in other embodiments some steps may occur in a different order than shown, some steps may be performed concurrently, some steps may be combined with other steps, and some steps may be absent.

In block 302, instructions of one or more software applications are processed by a computing system. In some embodiments, the computing system is an embedded system, such as a system-on-a-chip. The system may include multiple functional units that act as requestors for a shared data structure. The requestors may generate access requests.

In block 304, it may be determined a given requestor of two requestors generates an access request. In some embodiments, the access request is a memory read request. For example, an internal pixel-processing pipeline may be ready to read graphics frame data. Alternatively, the access request is a memory write request. For example, an internal pixel-processing pipeline may be ready to send rendered graphics data to memory for further encoding and processing prior to being sent to an external display. Other examples of access requests are possible and contemplated. Further, the access requests may not be generated yet. Rather, an indication of the access request may be generated and stored. At a later time when particular qualifying conditions are satisfied, the actual access request corresponding to the indication may be generated.

In block 306, an index storage may be accessed. The index storage may include multiple separate buffers. In some embodiments, a number of separate buffers may equal a number N of possible active requestors, wherein each requestor has a corresponding buffer. Each entry of the entries in the buffers may store both an indication of an access request and an index pointing to a corresponding entry in the shared data structure. Control logic may identify a corresponding buffer for a received access request from a given requestor.

If there is not an available entry in the corresponding buffer for the given requestor (conditional block 308), then in block 310, the system may wait for an available entry. No further access requests or indications of access requests may be generated during this time. The buffer may be full. If there is an available entry in the buffer for the given requestor (conditional block 308), then an entry may be allocated. If the buffer is empty, then the buffer may allocate the entry at a selected end of the buffer corresponding to the given requestor. This allocated entry corresponds to the oldest stored information of an access request for the given requestor. Otherwise, a next in-order contiguous unallocated entry may be used. In this case, the allocated entry may correspond to the youngest stored information of an access request for the given requestor. In various embodiments, the buffer may be implemented as a collapsible FIFO. In various other embodiments, the buffer may be implemented as a bipolar collapsible FIFO.

In addition to allocating an entry in a corresponding buffer, in block 312, an unallocated entry may be selected in the shared data structure for storing significantly large data associated with the request. An associated index for the selected entry may be sent to the index storage. In block 314, the corresponding buffer may store the received index in the recently allocated entry along with an indication of the request.

A memory read request may be determined to be processed when corresponding response data has been returned for the request. The response data may be written into a corresponding entry in the shared data structure. An indication may be sent to the associated buffer in the index storage in order to mark a corresponding entry that the read request is processed. In other cases, the access request is a memory write request. The memory write request may be determined to be processed when a corresponding write acknowledgment control signal is received. The acknowledgment signal may indicate that the write data has been written into a corresponding destination in the shared data structure.

If the response data is not ready (conditional block 316), then the entries remain allocated for the given outstanding request. If the response data returns and is ready (conditional block 316), then in block 318, a corresponding entry in the data structure is identified using the stored index. At this time, the stored index may have been accessed from the corresponding buffer at an earlier time and the index is provided in a packet or other request storage that was sent out to other processing blocks. In block 320, reading or writing significantly large data associated with the identified entry in the data structure services the access request.

In block 322, the stored processed data in the shared data structure and the indication of the access request may be sent to other processing blocks in later pipeline stages. At this time, the access request is processed or serviced, and corresponding entries in each of the shared data structure and the corresponding buffer may be deallocated. If deallocation of the buffer entry leaves a gap amongst allocated entries, then the remaining allocated entries for that requestor may collapse toward that requestor's selected end in order to close the gap. If on the other hand the deallocation does not leave a gap (e.g., the youngest entry was deallocated), then no collapse is needed.

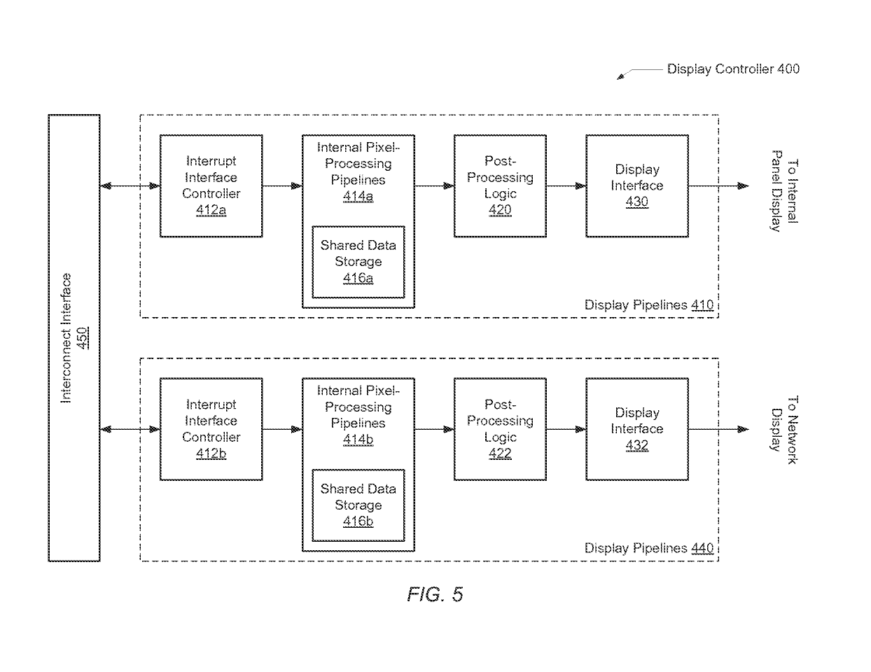

Turning now to FIG. 5, a generalized block diagram of one embodiment of a display controller 400 is shown. The display controller 400 is one example of a component that includes shared data storage. The shared data storage may include a shared data structure and an index storage as previously described above. The index storage may include one or more buffers implemented as collapsible FIFOs or bipolar collapsible FIFOs The display controller 400 may use the shared data structure for storing significantly large data. The display controller 400 may use the buffers for storing memory access requests and/or indications of memory access requests along with indices pointing to entries within the shared data structure.

The display controller 400 sends graphics output information that was rendered to one or more display devices. The graphics output information may correspond to frame buffers accessed via a memory mapping to the memory space of a graphics processing unit (GPU). The frame data may be for an image to be presented on a display. The frame data may include at least color values for each pixel on the screen. The frame data may be read from the frame buffers stored in off-die synchronous dynamic random access memory (SDRAM) or in on-die caches.

The display controller 400 may include one or more display pipelines, such as pipelines 410 and 440. Each display pipeline may send rendered graphical information to a separate display. For example, the pipeline 410 may be connected to an internal panel display and the pipeline 440 may be connected to an external network-connected display. Other examples of display screens may also be possible and contemplated. Each of the display pipelines 410 and 440 may include one or more internal pixel-processing pipelines. The internal pixel-processing pipelines may act as multiple active requestors assigned to buffers within the index storage.

The interconnect interface 450 may include multiplexers and control logic for routing signals and packets between the display pipelines 410 and 440 and a top-level fabric. Each of the display pipelines may include a corresponding one of the interrupt interface controllers 412a-412b. Each one of the interrupt interface controllers 412a-412b may provide encoding schemes, registers for storing interrupt vector addresses, and control logic for checking, enabling, and acknowledging interrupts. The number of interrupts and a selected protocol may be configurable. In some embodiments, each one of the controllers 412a-412b uses the AMBA® AXI (Advanced eXtensible Interface) specification.

Each display pipeline within the display controller 400 may include one or more internal pixel-processing pipelines 414a-414b. Each one of the internal pixel-processing pipelines 414a-414b may include one or more ARGB (Alpha, Red, Green, Blue) pipelines for processing and displaying user interface (UI) layers. In various embodiments a layer may refer to a presentation layer. A presentation layer may consist of multiple software components used to define one or more images to present to a user. The UI layer may include components for at least managing visual layouts and styles and organizing browses, searches, and displayed data. The presentation layer may interact with process components for orchestrating user interactions and also with the business or application layer and the data access layer to form an overall solution. However, each one of the internal pixel-processing pipelines 414a-414b handles the UI layer portion of the solution.

Each one of the internal pixel-processing pipelines 414a-414b may include one or more pipelines for processing and displaying video content such as YUV content. In some embodiments, each one of the internal pixel-processing pipelines 414a-414b includes blending circuitry for blending graphical information before sending the information as output to respective displays.

Each of the internal pixel-processing pipelines within the one or more display pipelines may independently and simultaneously access respective frame buffers stored in memory. The multiple internal pixel-processing pipelines may act as requestors that generate access requests to send to a respective one of the shared data storage 416a-416b. Although shared data storage is shown in the block 414, the other blocks within the display controller 400 may also include shared data storage.

The post-processing logic 420 may be used for color management, ambient-adaptive pixel (AAP) modification, dynamic backlight control (DPB), panel gamma correction, and dither. The display interface 430 may handle the protocol for communicating with the internal panel display. For example, the Mobile Industry Processor Interface (MIPI) Display Serial Interface (DSI) specification may be used. Alternatively, a 4-lane Embedded Display Port (eDP) specification may be used.

The display pipeline 440 may include post-processing logic 422. The post-processing logic 422 may be used for supporting scaling using a 5-tap vertical, 9-tap horizontal, 16-phase filter. The post-processing logic 422 may also support chroma subsampling, dithering, and write back into memory using the ARGB888 (Alpha, Red, Green, Blue) format or the YUV420 format. The display interface 432 may handle the protocol for communicating with the network-connected display. A direct memory access (DMA) interface may be used.

The YUV content is a type of video signal that consists of three separate signals. One signal is for luminance or brightness. Two other signals are for chrominance or colors. The YUV content may replace the traditional composite video signal. The MPEG-2 encoding system in the DVD format uses YUV content. The internal pixel-processing pipelines 414 handle the rendering of the YUV content.

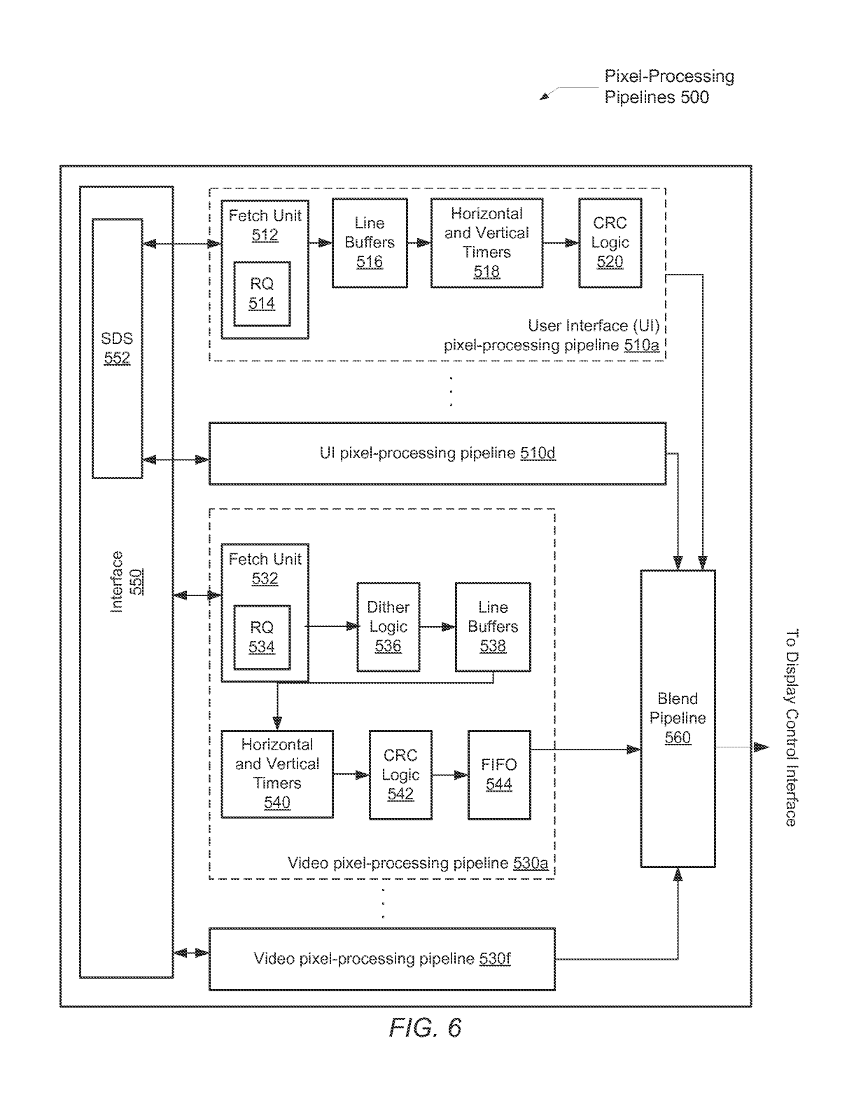

Turning now to FIG. 6, a generalized block diagram of one embodiment of the pixel-processing pipelines 500 within the display pipelines is shown. Each of the display pipelines within a display controller may include the pixel-processing pipelines 500. The pipelines 500 may include user interface (UI) pixel-processing pipelines 510a-510d and video pixel-processing pipelines 530a-530f.

The interconnect interface 550 may act as a master and a slave interface to other blocks within an associated display pipeline. Read requests may be sent out and incoming response data may be received. The outputs of the pipelines 510a-510d and the pipelines 530a-530f are sent to the blend pipeline 560. The blend pipeline 560 may blend the output of a given pixel-processing pipeline with the outputs of other active pixel-processing pipelines. In one embodiment, interface 550 may include one or more shared data storage (SDS) 552. For example, SDS 552 in FIG. 6 is shown to be shared by pipeline 510a and pipeline 510d. In other embodiments, SDS 552 may be located elsewhere within pipelines 500 in a location that is not within interconnect interface 550. All such locations are contemplated. In some embodiments, the bipolar collapsible FIFOs store memory read requests generated by the assigned internal pixel-processing pipelines. In other embodiments, the shared data storage stores memory write requests generated by the assigned internal pixel-processing pipelines.

The UI pipelines 510a-510d may be used to present one or more images of a user interface to a user. A fetch unit 512 may send out read requests for frame data and receive responses. The read requests may be generated and stored in a request queue (RQ) 514. Alternatively, the request queue 514 may be located in the interface 550. Corresponding response data may be stored in the line buffers 516.

The line buffers 516 may store the incoming frame data corresponding to row lines of a respective display screen. The horizontal and vertical timers 518 may maintain the pixel pulse counts in the horizontal and vertical dimensions of a corresponding display device. A vertical timer may maintain a line count and provide a current line count to comparators. The vertical timer may also send an indication when an end-of-line (EOL) is reached. The Cyclic Redundancy Check (CRC) logic block 520 may perform a verification step at the end of the pipeline. The verification step may provide a simple mechanism for verifying the correctness of the video output. This step may be used in a test or a verification mode to determine whether a respective display pipeline is operational without having to attach an external display.

Within the video pipelines 530a-530f, the blocks 532, 534, 538, 540, and 542 may provide functionality corresponding to the descriptions for the blocks 512, 514, 516, 518, 520 and 522 within the UI pipelines. The fetch unit 532 fetches video frame data in various YCbCr formats. Similar to the fetch unit 512, the fetch unit 532 may include a request queue (RQ) 534. The dither logic 536 inserts random noise (dither) into the samples. The timers and logic in block 540 scale the data in both vertical and horizontal directions. The FIFO 544 may store rendered data before sending it out. Again, although the shared data storage is shown at the input of the pipelines within the interface 550, one or more versions of the shared data storage may be in logic at the end of the pipelines. The methods and mechanisms described earlier may be used to control these versions of the shared data storage within the pixel-processing pipelines.

In various embodiments, program instructions of a software application may be used to implement the methods and/or mechanisms previously described. The program instructions may describe the behavior of hardware in a high-level programming language, such as C. Alternatively, a hardware design language (HDL) may be used, such as Verilog. The program instructions may be stored on a computer readable storage medium. Numerous types of storage media are available. The storage medium may be accessible by a computer during use to provide the program instructions and accompanying data to the computer for program execution. In some embodiments, a synthesis tool reads the program instructions in order to produce a netlist comprising a list of gates from a synthesis library.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a plurality of requestors configured to generate access requests for data;
a shared data structure comprising a first plurality of entries, each entry configured to store data for a respective one of the plurality of requestors;
a plurality of buffers, each comprising a respective second plurality of entries, wherein each buffer of the plurality of buffers is configured to:
store indications of access requests from a given requestor of the plurality of requestors in an in-order contiguous manner beginning at a first end;
store indices pointing to entries of the first plurality of entries in the shared data structure associated with the access requests from the given requestor; and
maintain an oldest stored indication of an access request from the given requestor at the first end.

2. The apparatus as recited in claim 1, wherein the apparatus further comprises control logic, wherein the control logic is configured to limit a total number of outstanding access requests to a given threshold M, wherein M is an integer.

3. The apparatus as recited in claim 2, wherein a size of the data stored in each of the first plurality of entries of the shared data structure times M times 2 requestors exceeds a given on-die real estate threshold.

4. The apparatus as recited in claim 2, wherein the control logic is further configured to:
receive a generated access request;
identify a given buffer of the plurality of buffers for the received access request;
identify a given entry of the first plurality of entries in the shared data structure for storing data for the received access request; and
store in the given buffer an associated index pointing to the given entry in the shared data structure.

5. The apparatus as recited in claim 2, wherein the control logic is further configured to deallocate in any order the allocated entries corresponding to the given requestor in the associated buffer.

6. The apparatus as recited in claim 5, wherein in response to deallocating an entry corresponding to the given requestor, the control logic is further configured to shift remaining stored indications of the given requestor toward the first end of the associated buffer such that a gap created by the deallocated entry is closed.

7. The apparatus as recited in claim 6, wherein the control logic is further configured to process out-of-order with respect to age the stored indications in the associated buffer.

8. The apparatus as recited in claim 7, wherein the stored indications of access requests comprise at least an identifier (ID) used to identify response data corresponding to the access requests.

9. The apparatus as recited in claim 8, wherein the first requestor corresponds to a first pixel-processing pipeline and the second requestor corresponds to a second pixel-processing pipeline.

10. The apparatus as recited in claim 7, wherein a given buffer of the plurality of buffers is further configured to:
store indications of access requests from a first requestor of the plurality of requestors in an in-order contiguous manner beginning at the first end; and
store indications of access requests from a second requestor different from the first requestor of the plurality of requestors in an in-order contiguous manner beginning at a second end, wherein the second end is different from the first end.

11. The apparatus as recited in claim 10, wherein the given buffer is further configured to maintain an oldest stored indication of an access request for the second requestor at the second end.

12. The apparatus as recited in claim 11, wherein any entry of the second plurality of entries in the given buffer may be allocated for use by the first requestor or the second requestor.

13. A method executable by a processor comprising:
receiving access requests for data generated from a plurality of requestors;
storing data for the plurality of requestors in a shared data structure;
storing indications of access requests from a given requestor of the plurality of requestors in an in-order contiguous manner beginning at a first end of a given buffer of a plurality of buffers;
storing indices pointing to entries in the shared data structure associated with the access requests from the given requestor; and
maintaining an oldest stored indication of an access request from the given requestor at the first end.

14. The method as recited in claim 13, further comprising limiting a total number of outstanding access requests to a given threshold M, wherein M is an integer, wherein a size of the data stored in each of the entries of the shared data structure times M reaches a given storage threshold.

15. The method as recited in claim 14, further comprising deallocating in any order the allocated entries corresponding to the given requestor in an associated buffer of the plurality of buffers.

16. The method as recited in claim 15, wherein in response to deallocating an entry corresponding to the given requestor, further comprising shifting remaining stored indications of the given requestor toward the first end of the associated buffer such that a gap created by the deallocated entry is closed.

17. The method as recited in claim 16, further comprising processing out-of-order with respect to age the stored indications in the associated buffer.

18. A non-transitory computer readable storage medium comprising program instructions operable to efficiently utilize a shared data structure dynamically in a computing system, wherein the program instructions are executable to:
receive access requests for data generated from a plurality of requestors;
store data for the plurality of requestors in a shared data structure;
store indications of access requests from a given requestor of the plurality of requestors in an in-order contiguous manner beginning at a first end of a given buffer of a plurality of buffers;
store indices pointing to entries in the shared data structure associated with the access requests from the given requestor; and
maintain an oldest stored indication of an access request from the given requestor at the first end.

19. The non-transitory computer readable storage medium as recited in claim 18, wherein the program instructions are further executable to limit a total number of outstanding access requests to a given threshold M, wherein M is an integer, wherein a size of the data stored in each of the entries of the shared data structure times 2M exceeds a given storage threshold.

20. The non-transitory computer readable storage medium as recited in claim 19, wherein the program instructions are further executable to:
deallocate in any order the allocated entries corresponding to the given requestor in an associated buffer of the plurality of buffers; and
in response to deallocating an entry corresponding to the given requestor, shift remaining stored indications of the given requestor toward the first end of the associated buffer such that a gap created by the deallocated entry is closed.
